(19) United States
(12) Patent Application Publication
(10) Pub. No.: US 2004/0257502 A1
(43) Pub. Date: Dec. 23, 2004

(54) Light-shielding layer for display device

(75) Inventors: Akira Hatakeyama, Shizuoka-ken (JP); Hidenori Gotoh, Shizuoka-ken (JP); Hideaki Ito, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/825,627

(22) Filed: Apr. 16, 2004

(30) Foreign Application Priority Data
Apr. 18, 2003 (JP) 2003-113614

(51) Int. Cl. G02F 1/1333

(52) U.S. Cl. 349/110

(57) ABSTRACT

A light-shielding layer for a display device including metal particles. The light-shielding layer has a film thickness of 0.9 μm or less and an optical density of 3.3 or more.

### CROSS-REFERENCE TO RELATED APPLICATION

This application claims priority under 35USC 119 from Japanese Patent Application No. 2003-113614, the disclosure of which is incorporated by reference herein.

### BACKGROUND OF THE INVENTION

1. Field of the Invention

The present invention relates to a light-shielding layer that can be utilized in a color filter used in a liquid crystal display device and other devices. The present invention also relates to a method for producing the light-shielding layer.

2. Description of the Related Art

The light-shielding layer is a black frame formed around red, blue and green pixels of a color filter and around a color filter in order to prevent light leakage; and a dot-shaped or line-shaped black pattern for the purpose of light shielding in thin film transistors (TFTs).

In color filters used in color liquid crystal displays or the like, pixel layers colored (in red (R), green (G) and blue (B)) are formed on a transparent substrate, and a light-shielding layer is formed in gaps between the colored pixels in R, G and B in order to improve display contrast. In particular, for liquid crystal display elements using active matrix driving system including thin film transistors (TFTs), the light-shielding layer is required to have a high light-shielding property (optical density) in order to prevent a decrease in image quality which follows current leakage in the thin film transistors by light.

In order to produce a light-shielding layer having a high light-shielding property, metal may be used. As a technique for using metal particles to form a light-shielding layer, Japanese Patent Application Laid-Open (JP-A) No. 5-303090 discloses a method of using a plating technique to generate nickel particles in a layer.

However, this method has drawbacks in that: it is necessary to perform a complicated operation of precipitating particles from a plating solution containing metal ions; treatment for plating solution waste is also complicated; and a large environmental burden is imposed. The thickness of the light-shielding layer obtained by this method is from 1 to 10 μm.

Methods for producing a light-shielding layer without using any plating technique are known. For example, JP-A No. 62-9301 discloses a technique of using carbon black instead of metal particles to form a light-shielding layer.

However, carbon black has a lower optical density per unit applied amount than metal particles. Thus, the thickness of the film made of carbon black inevitably becomes 1 μm or more in order to ensure high light-shielding property and optical density.

In the case of using a light-shielding layer which has a large film thickness, when red, blue and green pixels are formed after the formation of the light-shielding layer, it is unlikely that the formed pixels will be uniform.

An example of a technique for forming a thin light-shielding layer is as follows. When a metal film made of chromium or the like is used as a light-shielding layer, a metal thin film is formed by vapor deposition or sputtering; a photoresist is applied on the metal thin film; the photoresist layer is exposed and developed using a photo-mask having a pattern for a light-shielding layer; then the exposed metal thin film is etched; and finally the resist layer on the metal thin film is peeled off (see, for example, “Color TFT Liquid Crystal Display”, pp.218-220 (Jul. 20, 1996) published by Kyoritsu Shuppan Co., Ltd.).

Since a metal thin film is used in this method, the method can provide a high light-shielding effect even if the film thickness is small. However, the method has problems in that a vacuum film-forming step using vapor deposition or sputtering and an etching step are required so as to make costs high, and the environmental impact cannot be ignored. The method also has a problem that the light-shielding layer exhibits a high reflectivity since the matrix is made of the metal film, and display contrast is low under intense external light. In contrast, a method of using a low-reflectivity chromium film (such as a film composed of a metal chromium film and a chromium oxide film) is known. However, it is undeniable that this method is even more costly.

Accordingly, a technique for producing, at low cost, a light-shielding layer having sufficient optical density even as a thin film, is required.

Furthermore, for example, JP-A 7-218715 discloses a method of forming a shielding layer including metal sulfide particles by using plating. However, this method has intrinsic problems of plating such as an issue of environmental damage due to waste water and requirement for complicated steps, and thus is not satisfactory.

### SUMMARY OF THE INVENTION

In view of the above-mentioned problems, the present invention has been made. An object thereof is to provide a light-shielding layer which exhibits a high light-shielding performance even if the thickness thereof is small and can be produced at a low cost.

The present inventors made eager investigation. As a result, the inventors have found that a light-shielding layer including metal particles and having a film thickness and optical density within given ranges can solve the above-mentioned problems, and has made the invention.

A first aspect of the invention is to provide a light-shielding layer for a display device including metal particles, wherein the light-shielding layer has a film thickness of 0.9 μm or less and an optical density of 3.3 or more.

A second aspect of the invention is to provide a photosensitive transferring material for producing the light-shielding layer of the first aspect. The photosensitive transferring material includes a temporary support and a photosensitive layer disposed on the temporary support. The photosensitive layer is prepared by coating the temporary support with a photosensitive coating solution including metal particles and drying the same.

A third aspect of the invention is to provide a solution for producing the light-shielding layer of the first aspect. The solution includes metal particles.

A fourth aspect of the invention is to provide a substrate having the light-shielding layer of the first aspect disposed thereon.

A fifth aspect of the invention is to provide a color filter including the substrate of the fourth aspect.

A sixth aspect of the invention is to provide a method for producing a light-shielding layer including metal particles. The method includes: forming a photosensitive layer by applying a photosensitive coating solution including the metal particles onto a temporary support; drying the photosensitive layer; and transferring the photosensitive layer onto a substrate. The light-shielding layer has a film thickness of 0.9 μm or less and an optical density of 3.3 or more.

A seventh aspect of the invention is to provide a method for producing a light-shielding layer including metal particles. The method includes: forming a coating layer by applying a coating solution including the metal particles onto a substrate; and drying the coating layer. The light-shielding layer has a film thickness of 0.9 μm or less and an optical density of 3.3 or more.

### DETAILED DESCRIPTION OF THE INVENTION

A light-shielding layer of the present invention include metal particles. The light-shielding layer has a film thickness of 0.9 or less and an optical density of 3.3 or more.

The invention is described in detail hereinafter.

[Metal Particles]

The kind of the metal of the metal particles used in the invention is not particularly limited. Preferable examples thereof include nickel, silver, gold, platinum, copper, and alloys thereof. Of these examples, silver is preferable from the viewpoint of chemical stability and costs.

The metal particles used in the invention may have an even composition or an uneven composition. An example having an uneven composition include a light-shielding layer that has a coating layer on the surface thereof, the composition of which is different from that of the inside. The shape of each of the metal particles used in the invention is not particularly limited, and may be any one selected from various shapes such as spherical, indeterminate, plate-like, cubic, regularly octahedral, columnar and other shapes.

The average particle size of the metal particles used in the invention is preferably from 1 to 3000 nm, more preferably from 5 to 800 and still more preferably from 10 to 250 nm. If the average particle size is less than 1 nm, the absorption wavelength thereof becomes short. If the average particle size is more than 3000 nm, color may be generated or the optical density may be low.

The method for producing the metal particles used in the invention is not particularly limited. A known production method, for example, a gas-phase method such as an evaporation coagulation method or a gas-phase reduction method, or a liquid-phase method such as a liquid-phase reduction method may be adopted. Details thereof are described in “Latest Tendency I and II in Technique and Application of Superfine Particles”, published by S. B. TECHNO-RESEARCH CO., LTD. in 2002.

In the case of, for example, silver particles (colloidal silver), a conventional method as follows can be used: a method of reducing a soluble silver salt in an aqueous gelatin solution with hydroquinone, disclosed in U.S. Pat. No. 2,688,601; a method of reducing a slightly-soluble silver salt with hydrazine, disclosed in DE Patent No. 1,096,193; a method of reducing silver ions chemically in a solution, such as a method of reducing silver ions into silver atoms with tannic acid as described in U.S. Pat. No. 2,921,914; a method of forming silver particles by electroless plating, described in JP-A No. 5-134358; an in-gas evaporation method, in which a bulk metal is evaporated in an inert gas such as helium and then the metal is cold-trapped with a solvent; or the like.

[Dispersing Agent]

In the invention, the metal particles, in order to inhibit from coagulating in the coating liquid, are preferably dispersed by using a dispersing agent. Examples of the dispersing agent that can be used in the invention include a surfactant and a polymer.

Examples of the surfactant that can be used include all of anionic surfactants, cationic surfactants, nonionic surfactants and amphoteric surfactants. The anionic surfactants and the nonionic surfactants are particularly preferable. A HLB of the surfactant used in the invention is preferably in a range of about 8 to 18 in the case of water-based solvent and in a range of about 3 to 6 in the case of oil-based solvent, in general. However, the HLB of the surfactant cannot be chosen only on the basis of whether a solvent of the coating liquid is water-based or oil-based. Additionally, with respect to the HLB, one may refer to Kaimen Kasseizai Handbook (Handbook of surfactants) (ed. by Yoshida Tokiyuki et. al, Kougakutosho Ltd., 1987).

Specific examples of the surfactant include propylene glycol monostearate, propylene glycol monolaurate, diethylene glycol monostearate, sorbitol monlaurate and polyoxyethylene sorbitol monolaurate; and the surfactants described in the Kaimen Kasseizai Handbook.

The surfactant to be used is contained in the coating solution in an amount of 0.01 to 30% by weight, and more preferably in an amount of 0.1 to 20% by weight based on the metal particles.

As the dispersing polymers used in the invention, polymers having the protective colloid properties are preferable. Examples of the polymer include gelatin, polyvinyl alcohol, methyl cellulose, hydroxypropyl cellulose, polyalkylamine and partial alkyl ester of polyacrylic acid; and polymers described in Ganryou no Jiterm (ed. by Ito Seisirou, Asakura Shoten, 2000).

The polymer to be used is contained in the coating solution preferably in an amount of 0.01 to 30% by weight, and more preferably in an amount of 0.1 to 20% by weight based on the metal particles.

[Optical Density]

The optical density of the light-shielding layer of the invention is 3.3 or more, and preferably 3.5 or more.

Examples of the method for adjusting the optical density include a method of making the particle size of the metal particles small, a method of increasing the amount of the used metal particles, and a method of increasing the thickness of the light-shielding layer.

The film thickness of the light-shielding layer is 0.9 μm or less, preferably 0.6 μm or less and more preferably 0.4 μm or less.

The degree of swelling (S) of the light-shielding layer of the invention with respect to water at 25° C. is preferably 0.5 or less.

Here, the degree of swelling (S) is defined by S=(d′−d)/d when d represents a film thickness of a dry layer and d′ represents a film thickness of a layer immersed in distilled water at 25° C. for 60 seconds.

[Pigments Other than the Metal Particles]

The light-shielding layer of the invention contains metal particles as a black pigment component. If necessary, the light-shielding layer may contain one or more black pigments other than the metal particles. A typical example of the black pigment is carbon black.

[Ratio R]

In the light-shielding layer of the invention, a ratio (R) of optical density (OD) to applied pigment volume (V) (i.e., R═OD/V) is preferably 20 or more, more preferably 40 or more, and still more preferably 50 or more.

The word “pigment” in the wording “applied pigment volume” means all the pigments used, which include the metal particles and other pigments. When the light-shielding layer contains two or more kinds of metal particles, the word “pigment” includes all of them. When the applied amount of each pigment per 1 m² is represented by q g/m² and the density thereof is represented by p g/cm³, the applied volume v of the pigment can be defined by the equation of v=q/ρ. The applied pigment volume V can be defined as the total sum of the value v of each pigment.

Examples of a method for adjusting the ratio R within the above-mentioned range include a method of changing the kind of the pigments in the coating solution or the particle size thereof, and changing the ratio between the pigment(s) and a binder to be used.

If the ratio R is less than 20, it is necessary to make the film thicker in order to obtain required optical density and the qualities of red, green and blue pixels which are to be formed after the light-shielding layer is formed may deteriorate.

[Method for Producing the Light-Shielding Layer]

The light-shielding layer of the invention can be produced by a method including applying a coating solution including metal particles onto a substrate and drying the applied solution. As another embodiment, the light-shielding layer can be produced by a method including forming a photosensitive layer by applying a coating solution including metal particles onto a temporary support, drying the photosensitive layer, and transferring the photosensitive layer onto a substrate.

(Coating Solution Including Metal Particles)

In the present invention, the coating solution including metal particles may further contain a polymer as a binder, a solvent, and other components.

(Binder)

The binder to be used in the coating solution including metal particles of the present invention will be explained below.

Examples of the binder contained in the light shielding film of the invention include: polyvinyl alcohol, gelatin, cellulose type polymers such as methyl cellulose, and acrylic and styrene acrylic polymers obtained by polymerizing methyl methacrylate, ethyl acrylate, benzyl acrylate, acrylic acid, methacrylic acid, styrene, and the like.

Of these examples, acrylic and styrene acrylic polymers which contain an acrylic acid or methacrylic acid moiety and are soluble in alkali are preferable since the polymers can be patterned by alkali development.

In any one of these polymers, the content of the total of acrylic acid and methacrylic acid in the polymer is from 10 to 60% by mass, and more preferably from 20 to 50% by mass.

Specific examples of the polymers include benzyl methacrylate/methacrylic acid (60/40, (mass ratio, the following ratios are also mass ratios)); methyl methacrylate/styrene/methacrylic acid (10/60/30); methyl methacrylate/styrene/acrylic acid/methacrylic acid (20/50/15/15); benzyl methacrylate/methyl methacrylate/methacrylic acid (40/35/35); and styrene/acrylic acid/methacrylic acid (60/20/20).

The binder may be a monomer or an oligomer. It is preferable to use a polyfunctional acrylic monomer, specific examples of which include ethylene glycol (meth)acrylate, triethylene glycol di(meth)acrylate, 1,3-butanediol di(meth)acrylate, tetramethylene glycol di(meth)acrylate, propylene glycol di(meth)acrylate, trimethylolpropane tri(meth)acrylate, 1,4-hexanediol di(meth)acrylate, pentaerythritol hexa(meth)acrylate, and dipentaerythritol hexa(meth)acrylate.

These polyfunctional monomers can be crosslinked using light or heat, as described above. In this method, it is preferable to photopolymerize the monomer using, as a polymerization initiator, a halomethyl-S-triazine compound such as bis[4-[N-[4-(4,6-bistrichloromethyl-S-triazine-2-yl)phenyl]carbamoyl]phenyl]cebacate.

In order to improve the dispersion stability of the particles of the invention, a polymer may be added to the light shielding film of the invention. Examples of the polymer (the so-called dispersing agent) include polyvinyl alcohol, acrylamide/acrylic acid copolymer, styrene/maleic an hydride copolymer, sodium polyacrylate, and sodium alginate. Examples of the dispersing agent to be used include those described in “Pigment Dispersing Technique” (Technical Information Institute Co., Ltd.) published by Kazuhiro Takausu in 1999. Of these pigments, hydrophobic agents are particularly preferable.

(Solvent)

As the solvent, a conventionally known organic solvent can be used. Particularly preferable examples thereof include methyl alcohol, isopropyl alcohol, MEK, ethyl acetate, and toluene. Water is also preferable as the solvent. These solvents may be used in mixture if necessary.

(Substrate)

The substrate is preferably a glass substrate used in a liquid crystal display device or the like. The glass substrate may be a glass substrate using a known glass such as sodium glass, low-alkali glass, or non-alkali glass. The thickness of the substrate is preferably from about 0.5 mm to about 3 mm, and more preferably from about 0.6 mm to about 2 mm. Glass substrates described “Introduction to Liquid Crystal Display Engineering (written by Hanani Suzuki and published by the Nikkan Kogyo Shimbun, Ltd. in 1998)” can be used.

(Photosensitive Coating Solution Including Metal Particles)

The coating solution including metal particles in the invention can be made to have photosensitivity. In order to give photosensitivity to the solution, a photosensitive resin composition is added thereto. As the photosensitive resin composition, compositions described in JP-A No. 10-160926, paragraphs 0016 to 0022, and 0029 can be used.

In the case that the metal particles are used as a water dispersion, like the above-mentioned silver colloid, it is necessary that the photosensitive resin composition is of an aqueous type. Example of this photosensitive composition include compositions described in JP-A No. 8-271727, paragraphs 0015 to 0023, and commercially available products such as an “SSP-M20” manufactured by Toyo Gosei Co., Ltd.

(Embodiment of Producing Light-Shielding Layer by Applying Coating Solution to a Substrate)

A light-shielding layer of the present invention can be produced by a method including applying a coating solution including metal particles and drying the applied solution.

The method for forming a pattern of a light-shielding layer is not particularly limited. Examples of the pattern-forming method include the following methods:

(1) A method of applying a photosensitive coating solution including metal particles onto a substrate to form a light-shielding layer (a layer which contains metal particles), and then removing portions of the light-shielding layer other than a pattern portion by exposure and development, thereby forming a pattern.

(2) A method of applying a non-photosensitive coating solution including metal particles onto a substrate to form a light-shielding layer; applying a photosensitive resist liquid thereon to form a resist layer; patterning the resist layer by exposure and development; dissolving portions of the light-shielding layer other than a pattern portion corresponding to the pattern of the resist layer, so as to pattern the light-shielding layer; and finally removing the resist layer, thereby forming a light-shielding layer.

(3) A method of forming a coating layer beforehand on a substrate except a pattern portion; applying, on the coating layer, a non-photosensitive coating solution including metal particles to form a light-shielding layer; and then removing the initially-formed coating layer together with the light-shielding layer thereon.

In the invention, the method for the applying the coating solution on the substrate is not particularly limited. For example, the following can be used: a spin coating method described in JP-A No. 5-224011; curtain coating; extrusion; a die coating method described in JP-A No. 9-323472; or the like.

Spin coating is a method of dropping a coating solution onto a substrate which is being rotated, to spread the solution by centrifugal force.

Curtain coating, which is also called flow coating, is one type of a slot orifice coating method. This method is a method of dropping a coating solution into a curtain form from a slit, so as to be applied onto a substrate. The slit or the substrate is shifted in a horizontal direction so as to spread the coating solution, into an even thin layer form, onto the substrate.

Extrusion is a method which is also called extrusion coating, and is a coating method of spreading a coating solution extruded from a slit directly onto a substrate which is being shifted.

Details of the above-mentioned coating methods are described in, for example, “Coating Technique (supervised by Yuji Harasaki and published by K.K. Sogo Gijutsu Center in 1983)”.

The light source used in the exposure is selected in accordance with the photosensitivity of the light-shielding photosensitive resin layer. For example, a super high pressure mercury lamp, a xenon lamp, a carbon arc lamp, an argon laser or some other known light source can be used. As described in JP-A No. 6-59119, an optical filter having a light transmissivity of 2% or less at a wavelength of 400 nm or more may be used together.

As the developer for the development, a diluted solution of an alkaline material in water is used. A small amount of an organic solvent miscible with water may be added to the solution. Appropriate examples of the alkaline material include alkali metal hydroxides (such as sodium hydroxide, and potassium hydroxide), alkali metal carbonates (such as sodium carbonate, and potassium carbonate), alkali metal bicarbonates (such as sodium hydrogencarbonate, and potassium hydrogencarbonate), alkali metal silicates (such as sodium silicate, and potassium silicate), alkali metal metasilicates (such as sodium metasilicate, and potassium metasilicate), triethanolamine, diethanolamine, monoethanolamine, morpholine, tetraalkylammonium hydroxides (such as tetramethylammonium hydroxide) and trisodium phosphate. The concentration of the alkaline material is from 0.01 to 30% by weight, and the pH thereof is preferably from 8 to 14. The development based on film-elimination in the invention can be performed by changing, for example, the pH of the developer in accordance with the natures of the light-shielding photosensitive resin layer of the invention, such as the oxidizability thereof.

Appropriate examples of the organic solvent miscible with water include methanol, ethanol, 2-propanol, 1-propanol, butanol, diacetone alcohol, ethylene glycol monomethyl ether, ethylene glycol monoethyl ether, ethylene glycol mono-n-butyl ether, benzyl alcohol, acetone, methyl ethyl ketone, cyclohexanone, ε-caprolactone, γ-butyrolactone, dimethylformamide, dimethylacetoamide, hexamethylphosphonamide, ethyl lactate, methyl lactate, ε-caprolactam, and N-methylpyrrolidone. The concentration of the organic solvent miscible with water is generally from 0.1 to 30% by weight.

A known surfactant may be added to the developer. The concentration of the surfactant is preferably from 0.01 to 10% by weight.

The developer may be used in the form of bath liquid or spraying liquid. In order to remove the uncured portion of the light-shielding photosensitive resin composition layer in the form of solid (preferably in the form of a film), it is preferable to use a method of scraping off the portion with a rotating brush or a wet sponge in the developer, or a method of using spraying-pressure when the developer is sprayed. Usually, the temperature of the developer is preferably from room temperature to 40° C. A water-washing step may be performed after the developing treatment.

(Drying Step)

After the developing step, a heat-drying treatment is conducted. That is, the support having the resin photo-cured by the exposure (hereinafter referred to as the “photo-cured layer”) is heated in an electric furnace, a drying machine or the like, or the photo-cured layer is irradiated with light from an infrared ray lamp, so as to be heated. The temperature and the time for the heating depend on the composition of the polymerizable composition material used or the thickness of the formed layer. In general, in order to gain sufficient solvent resistance and alkali resistance, it is preferable to heat the support at a temperature ranging from about 120 to about 250° C. for about 10 to about 300 minutes.

(Embodiment of Producing Light-Shielding Layer by Using Transferring)

The light-shielding layer of the invention can be produced also by using a recording material having a photosensitive layer obtained by applying a photosensitive coating solution including metal particles onto a temporary support and drying the applied solution. The photosensitive layer of the recording material is transferred to a substrate. The recording material may be sometimes referred to as a “photosensitive transferring material”, hereinafter.

The photosensitive transferring material has, on a temporary support, a photosensitive light-shielding layer that is made from a photosensitive coating solution including metal particles.

The temporary support is preferably made of a flexible substance that is chemically and thermally stable. Preferable examples of the temporary support include a thin sheet made of Teflon (R), polyethylene terephthalate, polyethylene naphthalate, polyarylate, polycarbonate, polyethylene, polypropylene or the like and a laminate of these sheets. In the case that an alkali-soluble thermoplastic resin layer is formed, it is preferable that the temporary support has a good peelability from this resin. The approximate thickness of the temporary support is preferably from 5 to 300 μm, and particularly preferably from 20 to 150 μm.

It is preferable to form an alkali-soluble intermediate layer between the temporary support and the photosensitive light-shielding layer.

(Alkali-Soluble Intermediate Layer)

The resin constituting the intermediate layer may be any resin that is soluble in alkali solution. Examples of the resin include polyvinyl alcohol type resin, polyvinyl pyrrolidone type resin, cellulose type resin, acrylamide type resin, polyethylene oxide type resin, gelatin, vinyl ether type resin, polyamide resin, and copolymers thereof. It is also acceptable to use an alkali-soluble resin obtained by copolymerizing a monomer having a carboxyl group or a sulfonic acid group with a resin which is usually alkali-insoluble, such as polyester.

Of these examples, polyvinyl alcohol is preferable. The polyvinyl alcohol is preferably polyvinyl alcohol having a saponification degree of 80% or more, and more preferably polyvinyl alcohol having a saponification degree of 83 to 98%.

The resins, which constitute the intermediate layer, are preferably used in a mixture form of two or more thereof. It is particularly preferable to use a mixture of polyvinyl alcohol and polyvinyl pyrrolidone. The ratio by mass therebetween is as follows: the ratio by mass of polyvinyl pyrrolidone to polyvinyl alcohol is preferably from 1/99 to 75/25, and more preferably from 10/90 to 50/50. If the ratio by mass is less than 1/99, problems such that the surface state of the intermediate layer deteriorates or the adhesiveness thereof to the photosensitive resin layer applied onto the intermediate layer is poor may be caused. If the ratio by mass is more than 75/25, the oxygen-blocking ability of the intermediate layer may deteriorate to lower the sensitivity thereof.

If necessary, various additives, such as a surfactant, may be added to the intermediate layer.

The thickness of the intermediate layer is preferably from 0.1 to 5 μm, and more preferably from 0.5 to 3 μm. If the thickness is less than 0.1 μm, the oxygen-blocking ability may deteriorate. If the thickness is more than 5 μm, the time for removing the intermediate layer during development increases.

The solvent for applying the intermediate layer may be any solvent in which the above-mentioned resin can be dissolved. Water is preferable, and a mixed solvent wherein water is mixed with the above-mentioned water-miscible solvent is also preferable. Specifically, preferable examples of the solvent for applying the intermediate layer include water 100, water/methanol=90/10, water/methanol=70/30, water/methanol=55/45, water/ethanol=70/30, water/1-propanol=70/30, water/acetone=90/10, and water/methyl ethyl ketone=95/5. These ratios represent ratios by mass.

In the photosensitive transferring material, the photosensitive light-shielding layer made from the coating solution including the metal particles is formed as described above. From this, therefore, a light-shielding layer having a thin light-shielding layer having high optical density can be produced.

In the invention, a step of forming a protective layer on the light-shielding layer may be performed after the formation of the light-shielding layer and before the exposure. The protective layer is formed to block oxygen at the time of the exposure so as to improve the sensitivity of the photosensitive resin layer. Accordingly, the protective layer is preferably a layer made mainly of an oxygen-blocking resin such as polyvinyl alcohol. Since this layer is unnecessary after the formation of the light-shielding layer, the layer is removed by development.

The light-shielding layer of the present invention which is disposed on a substrate may be used in a color filter.

### EXAMPLES

The present invention will be described in more detail by way of the following examples. However, the examples should not be construed to limit the scope of the invention.

### Examples 1-1 to 1-3

[Production of Silver Particles]

(Production of a Silver-Dispersed Slurry)

To 112 g of gelatin was added 3,488 g of distilled water, and the resultant mixture was heated to about 47° C. to dissolve the gelation. Thereto were added 4.0 g of calcium acetate and 2.0 g of potassium hydrogenborate. Immediately after the addition, 6.0 g of silver nitrate dissolved in 1.0 L of distilled water was added to the solution while the solution was rapidly stirred. Thereto was added distilled water to adjust the final weight into 5.0 kg. Next, the resultant was cooled to a temperature close to the gelatinizing temperature thereof, and passed through small holes so as to be poured into cooled water, thereby generating very minute noodles. These noodles were supplied as an amplifying catalyst for producing blue silver in situ. For convenience sake and for preventing the noodles from being made into melt lump, water was used to dilute the noodles (ratio of water to the noodle: 1/3) To 650 g of silver nuclei reduced with hydrogen borate were added 6.5 g of potassium hydroquinone monosulfonate and 0.29 g of KCl dissolved in 81 g of distilled water. The noodle slurry was cooled to about 6° C. The following two solutions A and B were produced in separate containers.

A:

| | |
|---|---|
| (Anhydrous) sodium sulfite: | 19.5 g |
| (Anhydrous) sodium hyposulfite: | 0.98 g |
| Distilled water: | 122.0 g |

B:

| | |
|---|---|
| Silver nitrate: | 9.75 g |
| Distilled water: | 122.0 g |

The solutions A and B were mixed with each other. The mixture was continuously stirred to produce a white precipitation, which would disappear. Next, this mixture was immediately added to the noodle slurry rapidly in a short time (in 5 minutes) while stirred. The temperature was kept at 10° C., and the amplification was advanced for about 80 minutes until the whole of the soluble silver salt was reduced onto the nuclei. The resultant blue slurry particles were put into a nylon mesh bag, and tap water was passed through the slurry in the nylon mesh bag. The washing water was passed through the bag for about 30 minutes so as to wash the blue slurry particles. Consequently, the whole of the salt was washed away. Water was removed from the blue silver dispersed in the gel slurry and washed until the weight of the resultant product became 412 g, in such a manner that a blue silver dispersion containing silver at a concentration of 1.5% by weight would be obtained when the dispersion was melted. A transmission electron microscopic photograph demonstrated that the blue silver was made of definitely tabular particles having an edge length of about 20 to 30 nm and a thickness of about 7 nm.

(Production of Silver Particles)

To 4000 g of the silver dispersed slurry obtained as described above were added 6 g of a dispersing agent (trade name: Rapisol B-90, manufactured by Nippon Oil & Fats Co., Ltd.) and 2000 g of a 5% by weight solution of papain in water, and the resultant was stored at 37° C. for 24 hours. This solution was centrifuged at 2000 rpm for 5 minutes to precipitate silver particles. After the supernatant was removed, the solution was washed with distilled water to remove the gelation-decomposed product, which resulted from decomposition with the enzyme. Next, the silver fine particle precipitation was washed with methyl alcohol and then dried to yield about 60 g of an aggregate of the silver particles. 53 grams of the aggregate was mixed with 5 g of a dispersing agent (trade name: Solsperse 20000, manufactured by Avecia Ltd.) and 22 g of methyl ethyl ketone. Into this were incorporated 100 g of 2-mm glass beads, and the aggregate was dispersed in a paint shaker for 3 hours to yield a silver fine particle dispersion A-1.

(Preparation of a Light-Shielding Layer Coating Solution)

The following were added to the silver fine particle dispersion A-1, and the components were mixed to prepare a light-shielding layer coating solution.

| | |
|---|---|
| Silver particle dispersion A-1 | 40.0 g |
| Propylene glycol monomethyl ether | 40.0 g |
| acetate | |
| Methyl ethyl ketone | 37.6 g |
| Surfactant (F176PF, 20%) | 0.1 g |
| Hydroquinone monomethyl ether | 0.001 g |
| Dipentaerythritol hexaacrylate | amount for |
| | providing the R |
| | value shown in |
| | Table 1 or 2 |
| Bis[4-[N-[4-(4,6-bistrichloromethyl-s- | 0.1 g |
| triazine-2-yl)phenyl]carbamoyl]phenyl] | |
| sebacate | |
| (Preparation of a protective layer coating solution) | |
| Polyvinyl alcohol (trade name: PVA 205, | 3.0 g |
| manufactured by Kuraray Co., Ltd.) | |
| Polyvinyl pyrrolidone (trade name: PVP-K30, | 1.3 g |
| manufactured by GAF Corp.) | |
| Distilled water | 50.7 g |
| Methyl alcohol | 45.0 g |

A protective layer coating solution was obtained by mixing the above-mentioned components.

(Applying of the Coating Solutions)

A spin coater was used to apply the light-shielding layer coating solution on a glass substrate to set the optical density thereof into a value shown in Table 1, and the resultant was dried at 100° C. for 5 minutes. Next, a spin coater was used to apply the protective layer coating solution onto the light-shielding layer to have a dry film thickness of 1.5 μm. The resultant was then dried at 100° C. for 5 minutes.

(Exposure and Development)

A super high pressure mercury lamp was used to expose the member obtained above to light at 70 mJ/cm² from the side of the glass substrate surface coated with the above-mentioned layers. Next, the resultant was developed with a developing solution TCD (alkali developer, manufactured by Fuji Photo Film Co., Ltd.) at 33° C. for 20 seconds to provide light-shielding layers of Examples 1-1, 1-2 and 1-3.

Each of the resultant light-shielding layers was measured and evaluated as follows.

(Film Thickness Measurement)

The film thickness of the light-shielding layer was measured by the following method. A super high pressure mercury lamp was used to expose the sample coated with the light-shielding layer to light at 70 mJ/cm² from the side of the glass substrate surface coated with the light-shielding layer. The film thickness of this sample was measured with a probe-type surface roughness meter P-1 (trade name, manufactured by TENKOP Co.).

(Optical Density Measurement)

The optical density of the light-shielding film was measured by the following method. A super high pressure mercury lamp was used to expose the light-shielding layer coated onto the glass substrate to light at 70 mJ/cm² from the side of the glass substrate surface coated with the light-shielding layer. Next, the optical density (OD) thereof was measured with a Macbeth densitometer (trade name: TD-904, manufactured by Macbeth Co.). In the same manner, the optical density (OD₀) of the glass substrate was separately measured. The value obtained by subtracting the OD₀ from the OD was defined as the optical density of the film.

(R Value Measurement)

The applied amount of the silver particles was first measured by the following method.

A super high pressure mercury lamp was used to expose the sample coated with the light-shielding layer to light at 70 mJ/cm² from the side of the sample surface coated with the light-shielding layer. The applied amount of the silver in this sample was measured with a fluorescent X-ray device 3370E (trade name, manufactured by Rigaku Corp.).

This value of the applied amount of the silver and the optical density measured in the above-described manner were used to calculate the R value by the measure described in the section of detailed description of the invention.

(Measurement of Degree of Swelling)

The sample used in the film thickness measurement was immersed in distilled water at 25° C. for 60 seconds. After water on the surface of the sample was wiped, the film thickness (d′) of the sample was measured by the above-described method. The degree of swelling (S) was calculated with thus obtained d′ and the film thickness (d) of dried sample with the formula of S=(d′−d)/d. The result was 0.02.

(Formation of Blue, Red and Green Pixels and Evaluation of Air Bubbles in the Pixels)

The same samples R1, G1 and B1 of Example 1 as described in JP-A No. 2002-341127 were used to form red, green and blue pixels on the glass substrate on which the light-shielding layer was formed. As the method for forming the pixels, the same method as described in this publication was used.

Since the respective pixels were formed on irregularities of the light-shielding layer, air bubbles might enter gaps between the pixels and the glass substrate. The degree of the air bubbles generated was measured by the following method.

An optical microscope was used to observe 100 pixels out of the pixels in each of the colors on the glass substrate with the naked eye, that is, 300 pixels in all. The number of air bubbles was then counted.

(Hue Evaluation)

The glass substrate used in the air bubble evaluation was set up in a liquid crystal display device from the rear side thereof, and black and white colors were displayed. At this time, the contrast difference therebetween was observed with the naked eye to evaluate the sample in accordance with the following evaluation critera.

Very high contrast, and high quality: A.

High contrast, and considerably high quality: B.

Low contrast, and middle quality: C.

Very low contrast, and low quality: D.

### Comparative Examples 1-1 to 1-2

Light-shielding layers of Comparative Examples 1-1 and 1-2 were obtained in the same manner as in Examples 1-1 to 1-3 except that the added amount of dipentaerythritol hexaacrylate was changed so that the film thickness, the optical density and the R value were changed as shown in Table 1.

### Comparative Examples 2-1 and 2-2

Light-shielding layers of Comparative Examples 2-1 and 2-2 were obtained in the same manner as in Examples 1-1 to 1-3 except that the following carbon black dispersion B-1 was used instead of the silver fine particle dispersion A-1.

(Carbon Black Dispersion B-1)

The following were mixed: 5 g of carbon black (trade name: Regal 400, manufactured by Regal K.K.), 5 g of a dispersing agent (trade name: Solsperce 20000, manufactured by Avecia Ltd.), and 22 g of methyl ethyl ketone. Into this were incorporated 100 g of 2-mm glass beads, and the carbon black particles were dispersed in a paint shaker for 3 hours to yield a carbon black dispersion B-1.

The results are shown in Table 1.

TABLE 1

| | | Thickness | | | | |
|---|---|---|---|---|---|---|
| | | of photo- | | | | |
| | | sensitive | | | Air | |
| | Black | layer | Optical | | bubbles | |
| Sample No. | pigment | (μm) | density | R value | (number) | Hue |
| Comparative | Silver | 1.2 | 3.6 | 58 | 33 | A |
| Example 1-1 | | | | | | |
| Comparative | Silver | 0.80 | 2.5 | 40 | 8 | B |
| Example 1-2 | | | | | | |
| Comparative | Carbon | 1.8 | 3.6 | 7.2 | 53 | A |
| Example 2-1 | black | | | | | |
| Comparative | Carbon | 0.80 | 1.5 | 6.8 | 11 | D |
| Example 2-2 | black | | | | | |
| Example 1-1 | Silver | 0.80 | 3.6 | 55 | 10 | A |
| Example 1-2 | Silver | 0.80 | 3.6 | 56 | 11 | A |
| Example 1-3 | Silver | 0.35 | 3.6 | 58 | 0 | A |

### Examples 2-1 to 2-3

(Preparation of a Light-Shielding Layer Coating Solution)

A light-shielding layer coating solution was prepared in the same manner as in Examples 1-1 to 1-3.

(Preparation of an Intermediate Layer Coating Solution)

An intermediate layer coating solution was prepared in the same manner as in “the preparation of the protective layer coating solution” in Examples 1-1 to 1-3.

(Preparation of a thermoplastic resin layer)

| | |
|---|---|
| Copolymer made from methyl methacrylate/2- | 58 parts |
| ethylhexyl acrylate/benzyl | |
| methacrylate/methacrylic acid = 54/12/5/29 | |
| (ratio by mole) (number average molecular weight = 80000) | |
| Copolymer made from styrene/acrylic acid = 70/30 | 136 parts |
| (number-average molecular weight = 7000) | |
| Compound obtained by subjecting one equivalent | 90 parts |
| of bisphenol A and two equivalents of octaethylene | |
| glycol monomethacrylate to dehydration | |
| condensation (plasticizer, trade name: BPE-500, | |
| manufactured by Shin-Nakamura Chemical Co., | |
| Ltd.) | |
| Fluorine-containing surfactant (trade name: | 1 part |
| Megaface F176PF, manufactured by Dainippon Ink | |
| & Chemicals, Inc.) | |
| Methyl ethyl ketone | 541 parts |
| 1-Methoxy-2-propanol | 63 parts |
| Methyl alcohol | 111 parts |

The above-mentioned components were mixed to prepare a thermoplastic resin layer coating solution.

(Formation of a Transferring Material)

The thermoplastic resin layer coating solution was applied onto a biaxially-drawn polyethylene terephthalate support having a thickness of 75 μm so with a slide coater, as to have a thickness of 15 μm. The resultant was then dried at 100° C. for 5 minutes. Next, the intermediate layer coating solution was applied on the thermoplastic resin layer to have a thickness of 1.5 μm, and then dried at 100° C. for 5 minutes. Furthermore, the light-shielding layer coating solution was applied onto the intermediate layer to have optical density shown in Table 2 and then dried at 100° C. for 5 minutes.

(Formation of a Photosensitive Material)

The glass substrate and the transferring material were put onto each other to bring the glass substrate into contact with the light-shielding layer. A laminator (trade name: VP-II, manufactured by Osaka Laminator K.K.) was used to adhere the two to each other. About conditions for the lamination, the pressure was 0.8 kg/cm² and the temperature was 130° C. Thereafter, the polyethylene terephthalate support was peeled and removed.

(Production of a Light-Shielding Layer)

A super high pressure mercury lamp was used to expose the resultant photosensitive material to light at 70 mJ/cm² from the side of the glass surface coated with the layers, and then the following developing treatments were conducted so as to provide light-shielding layers of Examples 2-1,2-2 and 2-3.

(1) Developing treatment with a developing solution TPD (alkali developer, manufactured by Fuji Photo Film Co., Ltd.) at 30° C. for 40 seconds.

(2) Developing treatment with a developing solution TCD (alkali developer, manufactured by Fuji Photo Film Co., Ltd.) at 33° C. for 20 seconds.

(3) Developing treatment with the developing solution TCD (alkali developer, manufactured by Fuji Photo Film Co., Ltd.) at 33° C. for 20 seconds.

The samples were evaluated in the same manner as in Examples 1-1 to 1-3. The results are shown in Table 2 below.

### Comparative Examples 3-1 and 3-2

Light-shielding layers of Comparative Examples 3-1 and 3-2 were obtained in the same manner as in Examples 2-1 to 2-3 except that the added amount of dipentaerythritol hexaacrylate was changed so that the film thickness, the optical density and the R value were changed as shown in Table 2. Evaluations thereof are shown in Table 2.

TABLE 2

| | | Thickness | | | | |
|---|---|---|---|---|---|---|
| | | of photo- | | | | |
| | | sensitive | | | Air | |
| | Black | layer | Optical | | bubbles | |
| Sample No. | pigment | (μm) | density | R value | (number) | Hue |
| Comparative | Silver | 1.2 | 3.6 | 59 | 36 | A |
| Example 3-1 | | | | | | |
| Comparative | Silver | 0.8 | 2.5 | 54 | 11 | B |
| Example 3-2 | | | | | | |
| Example 2-1 | Silver | 0.80 | 3.6 | 61 | 12 | A |
| Example 2-2 | Silver | 0.80 | 3.6 | 57 | 12 | A |
| Example 2-3 | Silver | 0.35 | 3.6 | 58 | 0 | A |

According to the invention, it is possible to provide a light-shielding layer which can exhibit a high light-shielding performance (optical density) even if the matrix is thin, can be produced at a low cost, and can give good quality to red, blue and green pixels which will be formed thereon in a subsequent step.

What is claimed is:

1. A light-shielding layer for a display device comprising metal particles, wherein the light-shielding layer has a film thickness of 0.9 μm or less and an optical density of 3.3 or more.

2. The light-shielding layer of claim 1, wherein the light-shielding layer has a film thickness of 0.4 μm or less.

3. The light-shielding layer of claim 1, wherein a ratio R of optical density (OD) of the light-shielding layer to applied pigment volume (V) (R=OD/V) is 20 or more.

4. The light-shielding layer of claim 1, wherein a degree of swelling (S) of the light-shielding layer with respect to water at 25° C. is 0.5 or less.

5. The light-shielding layer of claim 1, wherein the metal particles comprise at least one selected from the group consisting of nickel, silver, gold, platinum, copper and alloys thereof.

6. A photosensitive transferring material for producing the light-shielding layer of claim 1, the photosensitive transferring material comprising a temporary support and a photosensitive layer disposed on the temporary support, wherein the photosensitive layer is prepared by coating the temporary support with a photosensitive coating solution comprising metal particles and drying the same.

7. A solution for producing the light-shielding layer of claim 1, wherein the solution comprises metal particles.

8. A substrate, having the light-shielding layer of claim 1 disposed thereon.

9. A color filter, comprising the substrate of claim 8.

10. A method for producing a light-shielding layer comprising metal particles, the method comprising: forming a photosensitive layer by applying a photosensitive coating solution including the metal particles onto a temporary support; drying the photosensitive layer; and transferring the photosensitive layer onto a substrate,
wherein the light-shielding layer has a film thickness of 0.9 μm or less and an optical density of 3.3 or more.

11. The method of claim 10, wherein the film thickness of the light-shielding layer is 0.4 μm or less.

12. The method of claim 10, wherein a ratio R of optical density (OD) of the light-shielding layer to applied pigment volume (V) (R=OD/V) is 20 or more.

13. The method of claim 10, wherein the metal particles comprise at least one selected from the group consisting of nickel, silver, gold, platinum, copper and alloys thereof.

14. The method of claim 10, further comprising forming an alkali-soluble intermediate layer between the temporary support and the photosensitive layer.

15. A method for producing a light-shielding layer comprising metal particles, the method comprising: forming a coating layer by applying a coating solution including the metal particles onto a substrate; and drying the coating layer,
wherein the light-shielding layer has a film thickness of 0.9 μm or less and an optical density of 3.3 or more.

16. The method of claim 15, wherein the film thickness of the light-shielding layer is 0.4 μm or less.

17. The method of claim 15, wherein a ratio R of optical density (OD) of the light-shielding layer to applied pigment volume (V) (R=OD/V) is 20 or more.

18. The method of claim 15, wherein the metal particles comprise at least one selected from the group consisting of nickel, silver, gold, platinum, copper and alloys thereof.

19. The method of claim 15, wherein the coating solution is photosensitive, and the method further comprises forming a pattern by removing portions of the coating layer other than a pattern portion by exposure and development.
